(19) United States
(12) Patent Application Publication
(10) Pub. No.: US 2009/0280449 A1
(43) Pub. Date: Nov. 12, 2009

(54) Apparatus and method for heat treatment

(75) Inventors: Christopher Dungey, Fradley Village (GB); Kevin D. Bass, Loughborough (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/453,204

(22) Filed: May 1, 2009

(30) Foreign Application Priority Data
May 6, 2008 (GB) 0808083.0

(51) Int. Cl. F27B 9/16; F27D 3/00; F27D 3/12; F27B 1/22; F27B 9/06; F27B 9/40

(52) U.S. Cl. 432/11; 432/18; 432/27; 432/121; 432/197; 432/124

(57) ABSTRACT

A furnace for heat treating components, especially relatively long components such as main shafts of gas turbine engines, comprises means for mounting a number of components vertically and conveying them repeatedly around a circular path surrounding one or more heating elements, while simultaneously rotating the components about their vertical axes. This allows uniform heat treatment of the components, even when long treatment times are needed. Loading and unloading chambers adjacent to the main chamber permit automated loading and unloading of components without disturbing the environment within the main chamber.

This invention relates to heat treatment of components. More particularly, it relates to heat treatment of relatively long components such as main shafts of gas turbine engines.

It is commonplace for engineering components to be heat-treated during their manufacture, in order that the completed component will have the desired mechanical properties.

Gas turbine engines typically have two or three main shafts, which run concentrically through the centre of the engine and transmit power from the turbines to their respective compressors.

The current method of shaft manufacturing is reliant upon batch techniques. There are a number of limitations with this process that do not lend themselves to high-volume manufacturing, such as the current furnace design for long components. Materials development is also necessitating increasingly long soak times associated with heat treatment and this can result in bottlenecks.

It would therefore be desirable to have an improved method for heat-treating such components that will reduce or overcome the problems inherent in known methods.

According to the invention, there is provided an apparatus and method for heat-treating a component as set out in the claims.

The invention will now be described, by way of example, with reference to the drawings in which

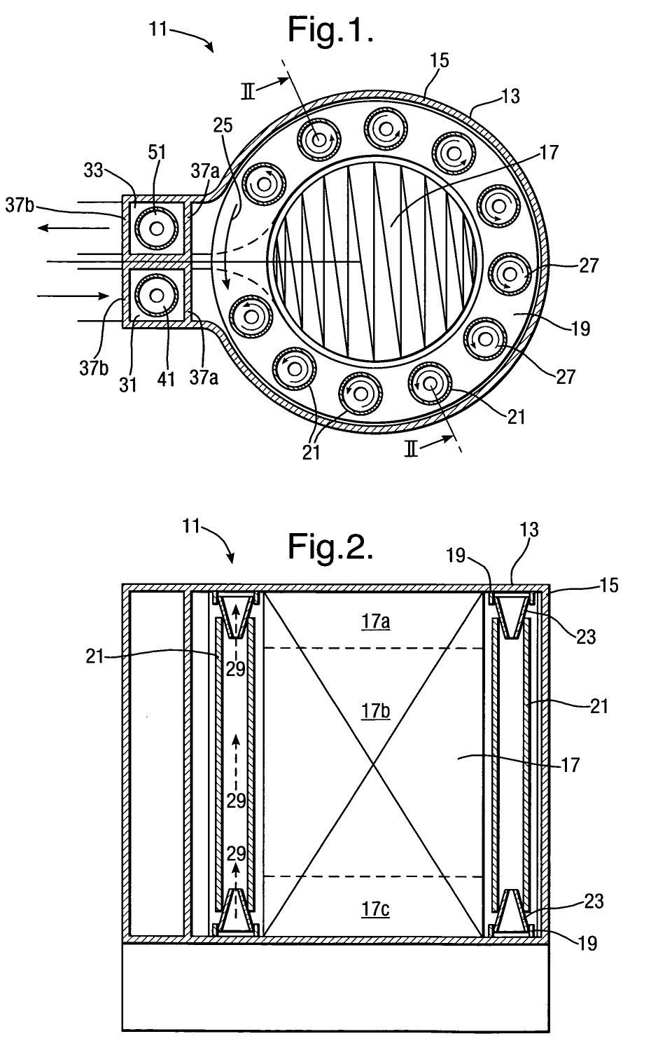

FIG. 1 is a schematic plan view of an apparatus according to one aspect of the invention; and

FIG. 2 is a schematic view on the line II-II of FIG. 1.

In FIGS. 1 and 2, a heat treatment furnace is shown generally at 11. The furnace comprises a generally cylindrical outer wall 13 incorporating insulation 15, defining a main chamber similar to those in current furnace designs. Within the main chamber, heating elements are mounted in a central region 17. Normally, the heating elements would be arranged around the periphery of the region 17. A circular carousel 19 extends around the central region 17, and carries a number of hollow shafts 21 which are to be heat-treated. Each hollow shaft 21 is supported vertically by a pair of hollow conical inserts 23 at its top and bottom ends. In use, the carousel 19 rotates in the direction of the arrow 25, carrying the shafts 23 around the heating elements in the central region 17 in an orbital motion. At the same time, a mechanism in the carousel 19 causes the inserts 23 to rotate, so that each shaft 21 simultaneously rotates about its axis, as shown by the arrows 27.

The speeds of rotation, both of the shafts 21 about their own axes and of the orbital rotation around the central region 17, will be determined and controlled according to the heat treatment requirements of the particular shaft 21.

Generally, the heat treatment will be of relatively long duration, so that the shafts will be carried repeatedly around the carousel and past the heating elements in the central region 17.

The carousel 19 operates generally in the same manner as those used in other applications, such as luggage carousels or those in postal sorting offices. The design of the carousel will of course be sufficiently robust to withstand both the weight of the components 21 and the environment in which it is to be used.

The hollow conical inserts 23 at the bottom ends of the shafts may be gear driven, or may be driven by other means. A mechanism may be provided so that the drive to the insert 23 is effected by the weight of the shaft 21 providing a downward force to provide engagement of the gears or other drive mechanism. The rotation of the inserts 23 may then be controlled independently through the control interface. The top inserts 23 are not driven, and are adjustable in height to ensure the correct vertical alignment of the shaft 21.

The continuous rotation of the shafts, together with their orbital movement around the central heating elements, ensures that the heat treatment is uniform around the circumference of each shaft. The heating elements may be arranged to provide a different heat treatment at different positions along the length of each shaft. For example, the central region 17 may be divided into zones 17a, 17b, 17c, each zone being provided with independently controlled heating elements. Alternatively, it may be desirable to provide heat treatment only to part of the shaft, for example to heat-treat a newly welded joint without affecting the properties of the rest of the shaft.

In particular, shafts made from two or more dissimilar materials, which have been joined by a technique such as inertia welding, may benefit from different temperatures during post weld heat-treatment due to the differences in material properties. In such a case, the heating elements would be configured to provide suitable temperature profiles through manipulation of the zone temperatures.

As the furnace is self-contained and the components are constantly rotating, long duration heat treatments can be applied by controlling the main carousel 19 rotational speed as well as that of the individual shafts 21.

The heat treatment temperatures (and the temperatures in individual zones 17a, 17b, 17c if zoned heat treatment, as described above, is used) may be varied with time to provide a more complex heat treatment.

A further advantage of the invention is provided by the mounting of the shafts 21 on hollow inserts 23. Gas can be pumped, or allowed to flow, through one insert 23, along the length of the inside of the shaft 21, and out through the other insert 23, as shown by the arrows 29 in FIG. 2. This would allow for an equilibrium heating state to occur, in which the temperature of the inside of the shaft is the same as the temperature of the outside; or, conversely, would allow for differential thermal states to be applied, in which the temperature of the inside of the shaft is different from that of the outside.

The gas may be atmospheric air, or a different gas or mixture of gases may be used. Typical reasons for providing such an alternative environment would be to provide an inert atmosphere or to promote a beneficial change in the metallurgy of the shaft being treated.

As described above for the main chamber heating elements, the temperature and environment of the region within the shafts may also be varied with time to achieve the desired heat treatment.

In an alternative embodiment, one or more heating elements may be provided within each of the hollow shafts. This permits heat treatment of a specific part of the inside of the shaft, or of the whole of the interior. It would also be possible to provide zoned heating of the inside of the shaft, which (as explained previously) is beneficial in the heat treatment of shafts made from dissimilar materials. The provision of discrete heating elements inside the shafts also provides better control of the heating of the shafts' interiors than can be achieved by passing gas through them.

This embodiment may be combined with the arrangement described previously in which gas is passed through the interiors of the shafts, for example to provide an inert atmosphere for the heat treatment.

In any embodiment, the temperature or temperatures inside the shafts may be the same as those in the corresponding zones outside the shafts, or may be different.

The furnace 11 also has provision for automated loading and unloading of shafts. A loading chamber 31 and an unloading chamber 33 are provided in the outer wall 13 of the furnace 11. Both chambers 31, 33 have hinged doors 37 at each end, the inner doors 37a communicating with the furnace and the outer doors 37b communicating with a separate conveyor (not shown) adjacent to the furnace. The use of hinged doors minimises the space required for the installation of the furnace 11. The doors 37a, 37b are provided with suitable seals so that when both sets of doors are closed the chambers 31, 33 can be substantially isolated both from the furnace 11 and from the environment outside the furnace 11.

A new shaft 41 to be loaded into the furnace is mounted at its top and bottom ends on a pair of hollow inserts 23, as described above. The outer doors 37b are opened and the shaft 41 loaded into the loading chamber 31, then the outer doors 37b are closed. Heating elements then heat up the shaft either to the temperature of the furnace 11 (or, at least, close to that temperature), or to a required pre-heat temperature, before the inner doors 37a are opened. This minimises the disturbance to the thermal conditions within the furnace. A bleed from the main furnace environment into the loading chamber may be provided, to minimise the energy needed to bring the chamber 31 up to the required temperature. The new shaft 41 is then moved into the furnace and takes up a position on the carousel.

In a similar way, shafts may be unloaded from the furnace once their heat treatment is complete. Heating elements in the unloading chamber 33 pre-heat the chamber to the same temperature as the furnace. The doors 37a of the chamber 33 open to allow the shaft 51 to be moved off the carousel and into the chamber 33. The doors 37a then close. The temperature in the chamber 33 can then be adjusted to provide a controlled cooling of the shaft 51, before the outer doors 37b are opened to allow the shaft 51 to be removed.

The invention can be employed to heat treat components for a number of different reasons, such as stress relief, ageing or microstructural manipulation. The use of different zones within the furnace, as explained above, would allow these effects to be localised if necessary. Different types of heat treatment, or in different zones, could be applied simultaneously or sequentially if complex patterns of heat treatment were required.

The environment inside the furnace can also be controlled, using known techniques, to provide heat treatment in, for example, a vacuum or an inert atmosphere. If such an environment is to be used, the loading and unloading chambers may also be provided with suitable equipment to replicate the furnace conditions, so that (as explained above with respect to temperature) the disturbance to the furnace conditions when components are loaded and unloaded can be minimised.

The invention therefore provides an apparatus for heat treatment that provides greater flexibility in use than known arrangements, and is particularly well adapted for long duration heat treatments. The apparatus allows a greater throughput of components, without any detrimental effect on components already undergoing heat treatment, by means of the loading and unloading chambers. Because the components are loaded vertically, the apparatus occupies far less space than conventional heat treatment furnaces.

Although only a single embodiment of the invention has been described, the skilled reader will appreciate that modifications may be made without departing from the scope of the claimed invention.

The apparatus and method described may be applied to solid, as well as to hollow, shafts. In this case, the shaft may be mounted on cupped or dished inserts instead of on the conical inserts 23 described above.

The apparatus and method described may equally well be applied to components other than shafts, and to components in any field of industry, not only to gas turbine components.

In particular, the main chamber of the furnace may be of a shape other than circular. Instead of a circular carousel, a conveyor of appropriate shape would be provided to transport the components past the heating elements. For example, an oval or rectangular chamber could be utilised.

Alternatively, with a suitable conveyor design, a furnace could be provided in which the components are rotated about their axes while being conveyed through a single-pass, linear furnace. In such a furnace, heating elements could be provided on one side or on both sides of the conveyor.

We claim:

1. An apparatus for heat treating a component, the apparatus comprising a main chamber, the main chamber comprising at least one heating element and means for mounting the component in use and means for conveying the component past the at least one heating element in use, characterised in that the mounting means comprise means for rotating the component while the component is conveyed past the at least one heating element.

2. An apparatus as claimed in claim 1, in which the component is hollow and in which the mounting means are adapted to permit a flow of fluid in use through the hollow part of the component.

3. An apparatus as claimed in claim 2, in which the temperature of the fluid is controlled independently of the temperature of the at least one heating element.

4. An apparatus as claimed in claim 1, in which at least one heating element can be controlled to provide different temperatures in different zones of the component.

5. A method for heat treating a component (21), the method comprising the steps of mounting the component within a main chamber and conveying the component past at least one heating element within the main chamber, characterised in that while the component is conveyed past the at least one heating element it is simultaneously rotated.

6. A method as claimed in claim 5, in which the component is hollow and in which the method further comprises the step of providing a flow (29) of fluid through the hollow part of the component.

7. A method as claimed in claim 6, in which the temperature of the fluid is controlled independently of the temperature of the at least one heating element.

8. A method as claimed in claim 5, and further comprising the step of controlling the at least one heating element to provide different temperatures in different zones (17a, 17b, 17c) of the component.
